(19) United States
(12) Patent Application Publication
(10) Pub. No.: US 2006/0253317 A1
(43) Pub. Date: Nov. 9, 2006

(54) Automated Voter Tracking System

(75) Inventors: Richard William Young, Absecon, NJ (US); David J. Cerrone, Galloway, NJ (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: First Tuesday In November, LLC, Absecon, NJ (US)

(21) Appl. No.: 11/383,304

(22) Filed: May 15, 2006

Related U.S. Application Data
(60) Provisional application No. 60/681,293, filed on May 16, 2005.

(51) Int. Cl. G07C 13/00

(52) U.S. Cl. 705/12

(57) ABSTRACT

A method of acquiring, storing and distributing information about one or more client specified voters is disclosed. The method includes: (1) storing publicly available information about each of the plurality of client specified voters in a central facility; (2) electronically transmitting a portion of the publicly available information stored in the central facility to a first remote terminal, (3) electronically transmitting from the remote terminal to the central facility, an identity of each one of the plurality of client specified voters that arrives at a polling location as soon as the identity of each one of the plurality of voters is identified to the remote terminal, whereupon client confidential information stored in the central facility is automatically updated with the voter's identity; and (4) providing access to a portion of the confidential information in the central facility, including the updated information, to an authorized user.

### CROSS-REFERENCE TO RELATED APPLICATIONS

This application claims the benefit of U.S. Provisional Application No. 60/681,293, filed May 16, 2005, entitled “Method and Apparatus for Voter Tracking”, the contents of which are incorporated herein by reference in their entirety.

### BACKGROUND OF THE INVENTION

1. Field of the Invention

This application is directed to a method and apparatus for acquiring, storing and distributing voter information and more particularly to distributing the voter information to authorized persons during a period of voting.

2. Background Information

Fundamental to a political party gaining advantage in an election is getting the party faithful to vote in the election. Local party organizations are assigned the responsibility of getting the party faithful to vote. Typically, the local party organizations use poll watchers assigned to polling stations to determine which of the party faithful appear at a polling station to vote in the current election. The poll watchers periodically provide the names of voters who have appeared to other party volunteers. These volunteers contact the voters who have not yet appeared at a polling station to encourage them to vote.

The present system of distributing the names of voters who have voted to those who can act on the information is inefficient and untimely. Accordingly, there is a need to provide means for acquiring and distributing voting information to party volunteers in a timely manner such that the likelihood is increased that a voter, favorable to the party candidates, votes in the current election.

### BRIEF SUMMARY OF THE INVENTION

The present invention is a method of acquiring, storing and distributing information about at least one of a plurality of client specified voters. The method comprises the steps of: storing publicly available information about each of the plurality of client specified voters in a central facility; electronically transmitting a portion of the publicly available information stored in the central facility to a first remote terminal in the possession of a poll watcher, the poll watcher being assigned to a predetermined polling location; electronically transmitting from the remote terminal to the central facility, an identity of each one of the plurality of client specified voters that arrives at the polling location as soon as the identity of each one of the plurality of voters is identified to the remote terminal by the poll watcher, whereupon client confidential information stored in the central facility is automatically updated with the voter's identity; and providing access to a portion of the confidential information in the central facility, including the updated information, to an authorized user.

Another aspect of the invention is a system for acquiring, storing and distributing voter information comprising: a central facility storing publicly available and client confidential information about each one of a plurality of client specified voters; at least one first remote terminal operatively connected to the central facility, said first terminal being configured to receive a portion of the publicly available information from the central facility and to provide updating information to the client confidential information; and at least one second remote terminal operatively connected to the central facility, said second terminal being configured to receive a portion of the client confidential information from the central facility.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown

In the drawings:

FIG. 1 is a block diagram of a system for receiving, storing and distributing voter information according to a preferred embodiment;

FIG. 2 is a block diagram of a database schema according to the preferred embodiment; and

FIG. 3 is a block diagram of a representative client organization according to the preferred embodiment.

### DETAILED DESCRIPTION OF THE INVENTION

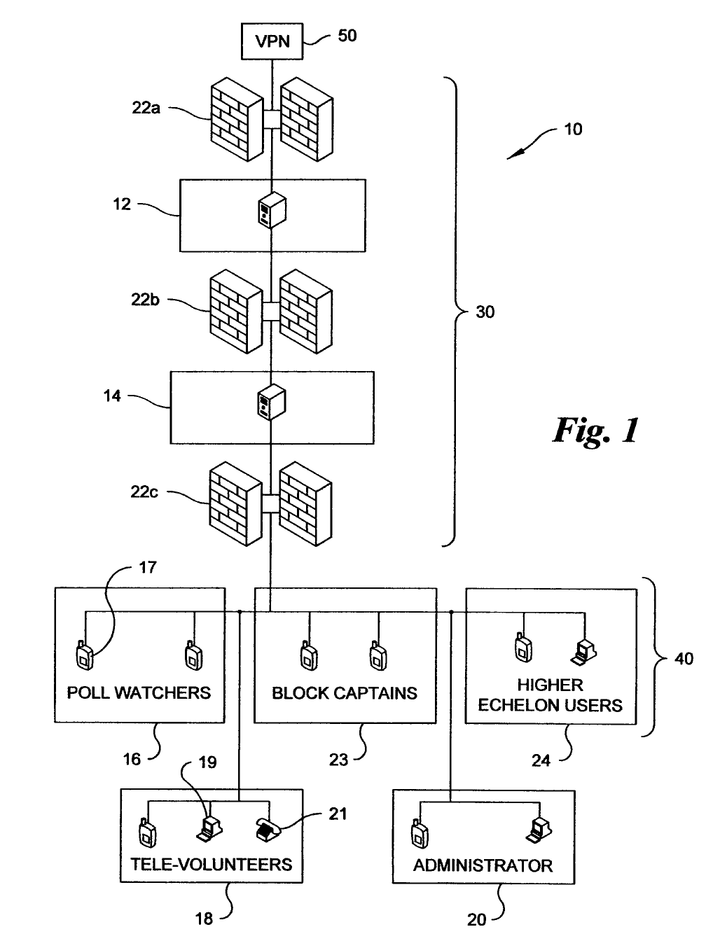

Referring now to FIG. 1 there is shown a block diagram of a preferred embodiment of a system 10 for acquiring and storing publicly available and client confidential voter information and for distributing the voter information and reports based on the voter information to a client during a period of voting. In the preferred embodiment of the system 10, the term “client” is associated with a particular political party. However, the term client may refer to any type organization or individual such as a candidate, union or the media, which seeks to acquire rapidly changing information about voters during a period of voting and who are voting at a polling location. The system 10, by its security design, is capable of simultaneously supporting multiple clients.

The preferred embodiment of the system 10 includes a central facility 30 and one or more remote terminals 40. The central facility 40 includes a back-end database server 12. Preferably, the database server 12 is an IBM zSeries S/390 mainframe computer running Linux Virtual Server (LVS) in separate logical partitions (LPARs). Each Linux instance is isolated from others running on the database machine 12, providing a similar level of separation as would be provided by separate physical servers. One skilled in the art would understand that other types of computers could be used in place of the IBM S/390 computer. Further, the mainframe computer operating as the database server 12 could be replaced by a plurality of computers and still be within the spirit and scope of the invention.

A database management system (DBMS) is used for storing and retrieving the voter information. The DBMS runs on a single LPAR on the database server 12. Preferably, an IBM DB2 DBMS is used as the DBMS but other DBMSs could be used. Additional LPAR's and/or server computers may be added to the database server 12 for scalability during periods of peak activity to handle higher work load, such as could be needed during a period of voting.

The database server 12 resides on a separate fire walled physical network from an application server 14 (see below), with the only point of connection between them being a redundant firewall 22b (see below).

The back-end database server 12 is directly accessible through firewall 22a for the express purpose of maintenance of the system 10. The firewall 22a is configured to act only as Layer 2 Tunneling Protocol (L2TP) Internet Protocol security (IPSec) virtual private network (VPN) tunnel endpoints for access from a VPN 50 using public key cryptography for authentication.

The preferred embodiment of the central facility 30 also includes an application server 14. The application server 14 provides an interface between the remote terminals 40 and the back-end database 12, including a web client for servicing wired Internet connected remote terminals and a PDA application for servicing wireless connected remote terminals 40. Preferably, the application server 14 employs an IBM zServer mainframe computer running LVS in separate LPARs. However, another type of computer and/or operating system could be used in place of the IBM mainframe computer and/or LVS operating system. Further, the mainframe computer operating as the application server 14 could be replaced by a plurality of computers and still be within the spirit and scope of the invention.

The preferred embodiment of the central facility also includes firewalls 22b, and 22c. The firewall 22b between the application server 14 and the back-end database server 12 allows only a network interface designated as internal, and addressed appropriately to connect or route through the firewall 22b to the backend database server 12. Only traffic from a known host (both IP and MAC addresses must be known) within the application server 14 to the database server 12 are allowed. No other traffic is allowed to pass through, and again the traffic that is passed is scrubbed.

The preferred embodiment of the system 10 also includes one or more remote terminals 17, 19, 21, the type of which is particularly suited to a specific class/type of user. Poll watchers 16 and block captains 23 are preferably provided with wireless personal digital assistants (PDA) 17 for wireless communication with the central facility 30 via the Internet. In the preferred embodiment the PDA 17 is a Research in Motion (RIM) Blackberry® device running a custom built Java-based application that utilizes the Java Mobile Information Device Profile (MIDP). Preferably, the PDA 17 is operative to store data input by the poll watcher 16, block captain 23 or other user, whether or not the PDA 17 is on-line with the central facility 30 or off-line with the central facility 30. The information stored in the PDA 17 is automatically uploaded to the central facility 30 when the PDA 17 goes from off-line to on-line.

Tele-volunteers 18, administrators 20 and upper echelon users 24 may be provided with either a PDA 17 or a computer 19 having Internet access, and a telephone 21.

Preferably, the PDA 17 and the computer 19 provided to the various classes of users 16, 18, 20, 23 and 24 are event driven for uploading information from the PDA 17, or computer 19 to the central facility 30. The PDAs 17 and the computers 19 provided to the various users 16, 18, 20, 23 and 24, periodically query the central facility 30 for updates to the data stored in the central facility 30, as described below.

The system 10 provides for receiving and separately storing in the database server 12, two types of voter related information: (1) registered voter information of public record, and (2) client specific (confidential) information that includes information that pertains to registered voters, each client, and to client workers.

Registered voter information of public record is generally obtained from the Board of Elections responsible for registering voters but may be received from other public sources. Preferably, the voter information of public record stored in the system 10 includes, but is not limited to, the voter's full name, address, date of birth and political party affiliation. In addition to the aforementioned information, a Board of Elections typically makes available information on dates when voters have checked in at the polls to vote, although no time information is available. Voter information that is obtained from public sources of information is considered to be available to all clients. Because of the public nature of the source of the voter information, the voter information stored in the system 10 may only be edited by system staff members (see below). In the system 10, each voter is assigned an arbitrary identification number (ID) that uniquely identifies one individual and has no specific meaning outside of the system 10.

In addition to public information, a client is able to store information related to specific voters that is considered confidential to the client. This type of information includes, but is not limited to, personal details about the specific voters such as spouse or children's names and ages, job information, preferred time of day during which to vote, times when the voter checks in at the polls, and so forth. Due to the confidential nature of the data, it is stored on a per client basis. Client party information is correlated to specific voters by reference to the specific voter's ID number.

The system 10 supports different user classes/types, some of which acquire voter information (e.g. poll watchers 16) and input the information into the system 10, and some of which receive the voter information and reports (i.e. authorized users) based on the voter information. Each of the users may be assigned a different level of permission and/or methods of accessing the system 10. The names of the user classes described following are generic and meant to indicate function and hierarchy. Accordingly, the exact names of the user classes may vary by the specific use of the system 10, as may the permissions and the hierarchy.

In the preferred embodiment, poll watchers 16 are assigned by the client to polling locations for the purpose of monitoring the polling locations during the majority of the polling period. Each of the poll watchers 16 monitors his/her assigned polling location to determine which of the voters registered at the polling location appear for voting at the polling location. Every poll watcher 16 possesses a unique login to the system 10 for the purposes of non-repudiation. The poll watchers 16 have extremely limited access to the system 10, with their capabilities limited to viewing only the names of the voters registered within their assigned location and assigning voting activity to the names of each voter that appears at the polling location.

Tele-volunteers 18 and block captains 23 are responsible for ensuring that all voters deemed most likely to vote for the party candidates fulfill their voting obligations. The list of voters assigned to each tele-volunteer 18 and each block captain 23 is initially determined prior to the election by administrators 20 and can be modified during the election-day so to optimize voter turnout. The tele-volunteer 18 is responsible for following-up with their assigned voters via telephone whereas the block captain 23 is responsible for following-up with their assigned voter's in-person.

In the preferred embodiment of the system 10, tele-volunteers 18 may login to the system 10 using a wired computer terminal 19. In the preferred embodiment, the tele-volunteer 18 using a wired computer terminal 19 is presented with a list (or series of lists) of registered voters for whom they are responsible. Upon selecting a particular voter presented by the computer terminal 19, the confidential information about the particular voter, such as voting history, comments or portions thereof, address and other contact information is downloaded from the central facility 30 to the computer terminal 19. The tele-volunteer 18 may then telephone the voter and enter comments into the computer terminal 19, such as “will visit polls around noon” or record the fact that there was no answer. The comments entered into the computer 19 are then uploaded to the central facility 30. Tele-volunteers 18 may not alter the list of voters that is assigned to them; voter assignment functionality is always carried out by administrators 20.

In the preferred embodiment, tele-volunteers 18 and block captains 23 may login via a PDA 17 terminal. Upon logging into the system 10 with a PDA terminal 17, a list of registered voters for whom they are responsible as well as the entirety of the confidential information associated with each voter, such as voting history, comments or portions thereof, address and other contact information for each of the voters is downloaded from the central facility 30 to the PDA 17. By downloading all of the information required to support the activities of the tele-volunteer 18 and the block captain 23 when they are using a PDA 17, the tele-volunteer 18 and the block captain 23 remain functional even if temporary loss of wireless communications occurs. When the download of information is completed, the tele-volunteer 18 and the block captain 23 are presented with the list (or series of lists) of registered voters. Upon selecting a particular voter identified in the PDA 17, the tele-volunteer 18 and the block captain 23 are presented with the particular voter's confidential information previously stored in the PDA 17. The block captain 23 may physically visit the voter and enter comments such as “will visit polls around noon” or record the fact that no one was home. The comments are then uploaded to the central facility 30. The block captain 23 may not alter the list of voters that is assigned to them; voter assignment functionality is always carried out by administrators 20.

Administrators 20 act as managers of sorts for the poll watchers 16, tele-volunteers 18 and block captains 23. Although administrators 20 have access to voter details and information, their primary focus is to oversee the progress and effectiveness of each of the poll watchers 16, block captains 23 and tele-volunteers 18. Upon logging into the central facility 30, administrators 20 are able to view metrics and details about voter turnout within their assigned geographic area. This provides details on how effective individual tele-volunteers 18 and block captains 23 are at getting voters out to the polls. When particular tele-volunteers 18 or block captains 23 have significantly lower turnout compared to others, the administrators 20 are able to reassign their assigned voters to others with higher voting percentages. Not only does this shift the burden from those who have many contacts to make, but it also increases the likelihood that these non-voting individuals are contacted by a volunteer who may be more effective at driving voters to the polls.

Further up the access hierarchy is higher echelon users 24 at the county, state and national levels. Users at these levels have access to metrics and information relative to their position. Users at these levels do not have permission to reassign individual responsibilities, but instead are responsible for delegating access to those at the level immediately below them. There is no foreseen situation where a national employee needs access to individual voter records, although they may be interested in the turnout and efficacy of particular geographic area.

Staff members include a database administrator, clerical personnel for entering information and maintenance personnel. Staff members are provided with specific permissions for accessing and editing the information stored in the system 10 and for performing maintenance on the hardware and software of the system 10. Preferably, staff members access the system through the VPN 50.

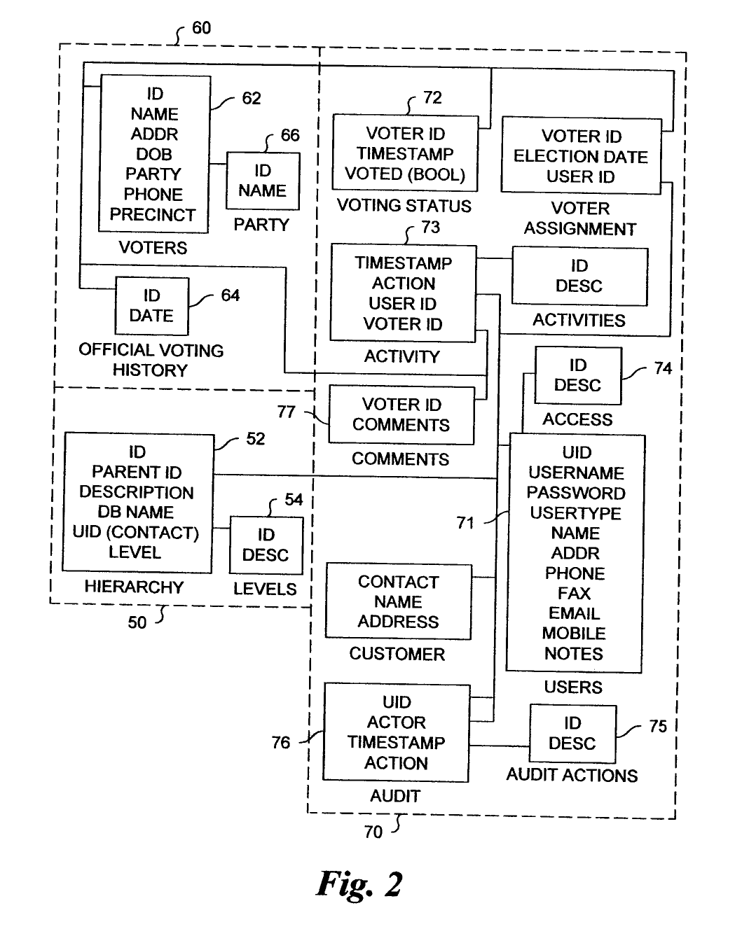

FIG. 2 is a block diagram of the database stored on the back-end database server 12 in accordance with the preferred embodiment. For security purposes, all client access and application server 14 access to the database residing in the database server 12 is through a read-only connection. Updates to the database are done only by staff members from the VPN 50. The updating of either past or recent voting records utilizes stored procedures within the back-end database 12 to ensure consistency and uniqueness of data. The stored procedures compare the voter name and registration information (party and district/precinct) of newly entered information to previously stored information. Depending on whether or not the voter is already known, their information is either updated or inserted.

The database comprises three parts: (1) a global voter database 60 containing the publicly available information (2) one or more client databases 70 containing the client confidential information, and (3) a global system database 50.

The global voter database 60 contains information about registered voters obtained from public records and comprises a voter database 62, a voting history database 64 and a party database 66. If the source of the information contains publicly available voting history information, such as a confirmation that the particular individual voted on a particular date, that information is stored in the voting history database 64. The voting history stored in the global voter database 60 is the official history of public record. A separate global database 60, each containing the same information, is created for each client in order to enhance security in the system 10.

The client database 70 is broken into a number of separate databases, each database being at a specific hierarchy level. User database 72 records all user login names and passwords to access the system 10, and personal information about each user. The user passwords are stored as the SHA1 hash of the user's actual password, to ensure the password is stored securely. A user ID (UID) is assigned to each user for internal use. Due to the nature of the system 10 to require a region code to be entered at user login, the system 10 allows for a unique username to be required only on a per-region, per-client basis. The user type (user class) field indicates whether the user is a poll watcher 16, tele-volunteer 18, block captain 23, administrator 20, and so forth. The access database 74 stores the textual definition of the different access levels, and the application is designed to be aware of the numerical value of each access level.

Every action a user may engage in that has any effect on data stored within the database is logged so that a full audit trail is always maintained. Actions in this category include, for example, marking a voter as having voted, adding comments relating to a voter, reassigning voters to a different block captain 23, and so forth. The audit actions database 75 contains a list of all these actions, with a coupled integer value and descriptive string. Application code contains statically defined constants associated with each of these audit actions. Every time a database event occurs, the timestamp is logged, along with the user generating the event, the action event ID, and as necessary, the ID of the voter associated with the action in the audit database 76.

Similarly, all significant actions a user commits within the system are logged in the activity log 73. This includes, for example, failed logins, password changes, user data edits, changing the access level of a user, and so forth. Behavior with respect to constants and ID values is the same as the audit database 76, with the only difference being the UID refers to the user who the audit entry relates to. The actor field in the audit database 76 relates to the user who caused the entry. Normally, events are generated by a user with respect to themselves, such as a failed login or manual password change. In this case, the actor field contains duplicate data, that is, the same user ID number as in the UID field. However if a user at the administrative level resets another user's password, the actor field contains the user ID of the user who reset the password of the user specified in the UID field.

Client specific voter information is stored in the voting status database 72 and comments database 77. The voting status database 72 contains client-recorded information on when people voted. The timestamp corresponds to when the polling location registrar identifies the registered voter's name so to indicate that the voter has signed in. At this time, the voted flag is set to “true”. If, for some reason, this is done accidentally, the program allows the voted flag to be set back to “false”.

The voting status database 72 is private to each client and is not shared across all clients. As such, a set of scripts exists on the database server 12 that instantiates new client instance of the voting status database 72 as new clients are added to the system 10. These scripts base the newly created database on the system-wide template from which all previous clients have been derived. Derivation and implementation based on this shared template ensures that all instances use the same format. Database maintenance and data handling accounts do not have the ability to alter the schema of any implemented databases. Fundamental schema changes affected by software revisions must first be made to the base template and then all clients migrated to the new database structure by a database administrator (DBA) at the same time during which the application is migrated. This may only be done during a maintenance window during which the system is deemed to be unavailable. A separate client database 70 is created for each client in order to enhance security in the system 10.

The global system database 50 contains the information which establishes a hierarchy within each client organization with respect to the different client offices (e.g. national, state, municipal, etc). The global system database 50 comprises a hierarchy database 52 and a level database 54.

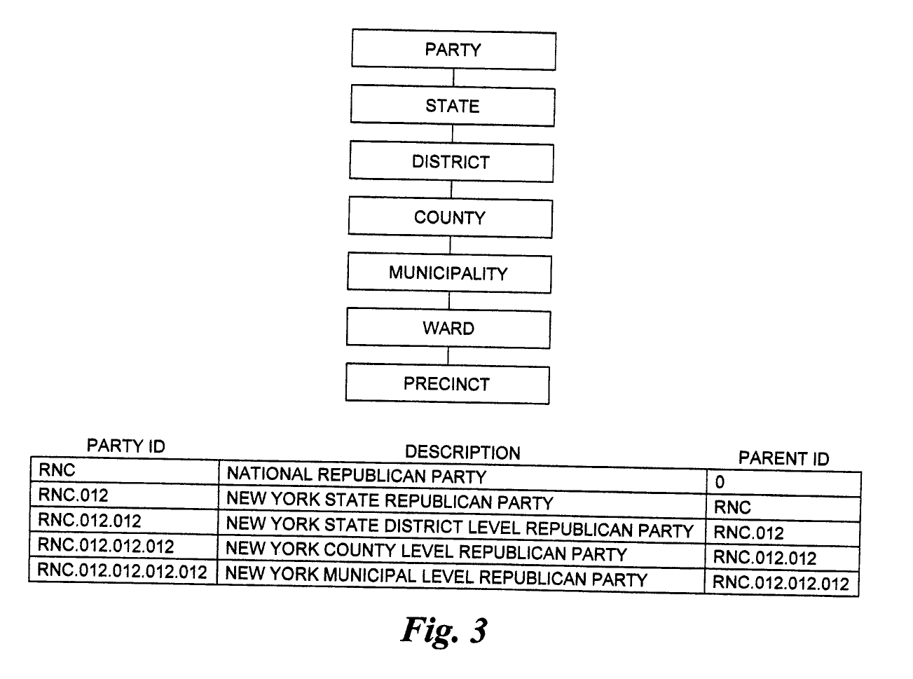

The global system database 50 is accessed whenever a user logs in to the system 10 and when a user alters client information. Every level within a client's hierarchy has a unique entry in the global system hierarchy database 52. A logical hierarchy tree (FIG. 3) is created by the client hierarchy database 52 using the parent ID field and all entries in the global system database 50 have a unique ID value corresponding to their full location ID and client name, which users are required to enter upon login. Every entry is required to contain the parent ID of the node in the hierarchy one level higher. The top node in the tree contains a parent ID value of 0. There may be any arbitrary number of entries at a particular level within the logical hierarchy. For example, if the system 10 is used nationally, there are fifty entries at the state level which exist with the parent ID ‘RNC’ and all of which may have any number of counties as children.

When a new client is introduced into the system, even if only for a select handful of municipalities, the full hierarchy from a national level on down should be present. This ensures that future expansion does not require any reworking of the database structure.

The level field (and level database 54) serves merely for quick access to information about where in the hierarchy the particular organization exists, and the textual description it points to in the level database is something along the lines of “national”, “state,” or “municipality.” Its sole purpose is informational. Because information is broken out into different databases, (see below), the particular database that exists corresponding to each level is named in this database.

When a user first attempts to login to the system 10, whether via the web client or the PDA 17 application, a user is required to enter three uniquely identifying pieces of information: their username, password, and the account of which they are assigned. Upon successful verification of the login information, the system 10 logs the user onto the system 10 and presents them with an interface appropriate to their user classification and the terminal 40 with which they are connecting to the central facility 30:

Upon a poll watcher 16 logging into the system 10, a portion of the publicly available voter information comprising a list of voters who are registered to vote in the particular poll watchers' 16 assigned polling location is downloaded from the central facility 30 to the poll watcher's 16 PDA 17. Generally, as voters check in with the registrar (poll worker who records the presence of the voter), their names are identified. One way they are identified is by their name being called out by the registrar.

When this occurs, the poll watcher 16 records the voter's name by selecting their name from a list on the PDA 17 and marks them as voting. Preferably, the list of voters may be navigated either by using the PDA 17's scrolling wheel, or by using the keyboard to enter the voter's last name. If the user chooses the keyboard, the list is traversed immediately upon each key press, so that the list can be navigated through as quickly as possible.

Where a wireless connection is available, information input to the PDA 17 (i.e. voters identity) is transmitted to the central facility 30 as soon as the information is entered into the PDA 17, whereupon the client confidential information stored in the central facility 30 is automatically updated with the identity of the voter and the time at which the update is made. Where connectivity is lost or the polling location is in an area where wireless communication is not possible, the PDA 17 automatically enters an off-line mode and the poll watcher 16 enters data into the PDA 17 in the off-line mode. Where connectivity is restored or becomes available by the poll watcher changing his location, the PDA 17 automatically resumes the on-line mode and information is automatically uploaded from the PDA 17 to the central facility 30. The application determines whether wireless connectivity exists by observing the strength and reliability of network connectivity.

Tele-volunteers 18 and block captains 23 have access to the client confidential information of all voters for which they are responsible, including whether or not they have voted, and are be able to delve deeper into the voter's information to view comments, personal information, voting history, and other recorded details. Administrators 20 are presented with a numerous list of actions they may be performed which includes, but is not limited to, the ability to create/modify/delete user profiles and the ability to view real-time statistics on the current voting activity. Upper Echelon Users 24, like administrators 20, also has access to real-time statistics on the current voting activity albeit at a higher level.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of acquiring, storing and distributing information about at least one of a plurality of client specified voters, comprising the steps of:
storing publicly available information about each of the plurality of client specified voters in a central facility;
electronically transmitting a portion of the publicly available information stored in the central facility to a first remote terminal in the possession of a poll watcher, the poll watcher being assigned to a predetermined polling location;
electronically transmitting from the remote terminal to the central facility, an identity of each one of the plurality of client specified voters that arrives at the polling location as soon as the identity of each one of the plurality of voters is identified to the remote terminal by the poll watcher, whereupon client confidential information stored in the central facility is automatically updated with the voter's identity; and
providing access to a portion of the confidential information in the central facility, including the updated information, to an authorized user.

2. The method of claim 1, wherein the portion of the publicly available information comprises the identity of each one of the plurality of client specified voters registered to vote at the polling location to which the poll watcher is assigned, the portion of publicly available information being automatically transferred to the poll watcher's remote terminal when the poll watcher, using the remote terminal, logs into the central facility.

3. The method of claim 1, further including the step of updating the confidential information with the time at which the identity of each one of the plurality of voters is transmitted to the central facility.

4. The method of claim 1, wherein the remote terminal is a wireless terminal.

5. The method of claim 1, wherein the authorized user possesses a second remote terminal, the second remote terminal being configured to obtaining and storing a portion of the confidential information from the central facility at the time that the second remote terminal connects to the central facility, the portion of the confidential information stored in the remote terminal being periodically updated thereafter upon request by the second remote terminal.

6. The method of claim 5, wherein the portion of the confidential information obtained from the central facility includes an identity of each one of the plurality of client specified voters assigned to the authorized user and an indication of whether or not each one of the plurality of voters assigned to the authorized user has arrived at the voter's assigned polling location.

7. The method of claim 6, further including the step of the authorized user selecting in the second remote terminal a particular one of the plurality of voters assigned to the authorized user, whereupon the entirety of the confidential information about the selected voter is automatically requested by the second remote terminal from the central facility.

8. The method of claim 5, wherein the portion of the confidential information obtained from the central facility includes an identity of each one of the plurality of client specified voters assigned to the authorized user and an indication of whether or not each one of the plurality of voters assigned to the authorized user has arrived at the voter's assigned polling location and the entirety of the confidential information about each voter assigned to the authorized user.

9. A system for acquiring, storing and distributing voter information comprising:
a central facility storing publicly available and client confidential information about each one of a plurality of client specified voters;
at least one first remote terminal operatively connected to the central facility, said first terminal being configured to receive a portion of the publicly available information from the central facility and to provide updating information to the client confidential information; and
at least one second remote terminal operatively connected to the central facility, said second terminal being configured to receive a portion of the client confidential information from the central facility.

10. The system according to claim 9, wherein said central facility comprises a database server and an application server, each of which operate in a logical partition and are operatively connected to each other through a firewall.

11. The system of claim 10, wherein a database resides on the database server, the database comprising at least one global voter database including the publicly available information and at least one client database including the client confidential information, access to the information in each global voter database and each client database being restricted to a predetermined client.

12. The system according to claim 9, wherein the first remote terminal is a wireless terminal.

13. The system according to claim 9, wherein the first remote terminal is operative in an on-line mode when operatively connected to the central facility for receiving the publicly available information from the central facility and for transmitting the updating information to the central facility as it is entered into the first remote terminal, and in the absence of connectivity to the central facility, the first remote terminal is operative in an off-line mode for receiving and storing the updating information as it is entered, wherein the stored updating information is automatically transmitted to the central facility upon entering the on-line mode from the off-line mode.
